(19) United States
(12) Patent Application Publication
(10) Pub. No.: US 2015/0317896 A1
(43) Pub. Date: Nov. 5, 2015

(54) SMART LABEL WITH INTEGRATED SENSOR

(71) Applicant: Solvera, Inc., Waterford, WI (US)

(72) Inventors: Peter Planton, Muskego, WI (US); Kevin Anderson, Kansasville, WI (US)

(73) Assignee: Solvera, LLC

(21) Appl. No.: 14/700,565

(22) Filed: Apr. 30, 2015

Related U.S. Application Data
(60) Provisional application No. 61/986,971, filed on May 1, 2014.

(51) Int. Cl. G08B 21/18; G06K 7/10

(52) U.S. Cl. CPC G08B 21/182; G06K 7/10366

(57) ABSTRACT

A smart label includes an antenna and an integrated sensor, and in response to receiving an initiating interrogation signal transmits a response signal that includes a first component that identifies the smart label and second component that provides data generated at the sensor in response to an environmental parameter. The response signal allows the data indicating the status of the environmental parameter, such as temperature or moisture, at the location of the specific smart label to be transmitted along with a time stamp. A method of activating a sensor on the smart label is also provided.

### CROSS REFERENCE TO A RELATED APPLICATION

The present application claims priority to U.S. Patent Application Ser. No. 61/986,971, filed May 1, 2014 and entitled “SMART LABEL WITH INTEGRATED SENSOR,” the subject matter of this which is hereby incorporated by reference in its entirety.

### BACKGROUND OF THE INVENTION

1. Field of the Invention

The invention relates generally to a “smart label” such as a radio frequency identification enabled label, and more particularly, relates to a flexible smart label having an integrated microprocessor sensor for sensing at least one environmental parameter. The invention additionally relates to methods of fabricating and a system using such a device.

2. Discussion of the Related Art

Advancements in radio frequency identification (RFID) based technologies and ongoing reduction in their manufacturing costs have resulted in a recent proliferation of RFID devices. These advancing technologies have seen significant growth in the area of hand-held applications, such as key fobs, access cards, and product location tracking tags, all of which utilize the transmission and/or reception of radio signals based on RFID technology. However, while RFID enabled products have become increasingly common, more complex uses such as flexible RFID labels with one or more integrated sensors that are capable of sensing at least one environmental parameters and transmitting a corresponding radio frequency signal have not. One of the most significant obstacles that presently inhibits flexible RFID products with integrated sensors is the ability to include a microprocessor, e.g. chip, within the flexible RFID circuit capable of performing a desired sensor function.

Prior attempts to combine wireless transmission devices such as RFID based technology with a sensor have resulted in bulky devices that are poorly-suited for widespread and variable commercial applications. Such devices are often relatively large in size, rigid in structure, and include a relatively large silicon wafer-based processor that receives input from a discrete sensor component and then transmits a signal through a discrete RFID circuit. For example, the RFID sensor described in U.S. Pat. No. 8,152,367 includes a temperature sensor that is not integrated into the microprocessor chip but, instead, is physically extended away from the body of the RF antenna. Furthermore, the rigid structure of this and other known devices makes them inherently bulky and inconvenient for compact applications. In addition, ridged RFID devices are also relatively more expensive to manufacture due in part to additional structural components.

Thus, despite prior attempts to provide a flexible RFID label having at least one integrated microprocessor sensors for sensing an environmental parameter such as temperature, there remains need for improvement.

### SUMMARY OF THE INVENTION

In accordance with a first aspect of the invention, a smart label is formed from a flexible substrate having a wireless transmitter such as a receiver in electrical communication with an integrated sensor. When the antenna or other receiver receives an incoming interrogation signal, the label transmits a response signal including a data component provided by the sensor and unique smart label identification component.

In one embodiment of the invention, the smart label is a RFID label, and the wireless receiver receives and transmits electromagnetic waves in the radio frequency range.

In one embodiment of the invention, receiver is an antenna, the sensor is a temperature sensor and the corresponding data component provided by the temperature sensor is a temperature data component. The RFID label receives power from the incoming interrogation signal to activate the temperature sensor's generation of the temperature data component to be included in the response signal. Transmission of the response signal to an interrogation device via the antenna, including both the temperature data component and unique label identification component, may also be powered by the incoming interrogation signal.

In accordance with another aspect of the invention, the response signal generated by the RFID label may also include an interrogation identification component, such as a counter that counts the number of interrogation signals received by the RFID label. By associating the response signal with the corresponding interrogation identification component, a time stamp may be provided for any given response signal.

In accordance with yet another aspect of the invention, the generation of the temperature data at the temperature sensor may include receiving an initial temperature sensor data and amplifying or otherwise converting the initial temperature sensor data into a final temperature sensor data that is subsequently transmitted in response signal.

In accordance with yet another aspect of the invention, the response signal may be transmitted at an ultra high frequency, in a range of approximately between 300 MHz and 3,000 MHz.

In accordance with yet another aspect of the invention, the temperature sensor may be formed from a carbon nanotube array, and more specifically may be formed from a semiconducting single-walled carbon nanotube array suspended between micro-scale electrodes.

In accordance with still another aspect of the invention, the temperature sensor may have a sensitivity of plus or minus 1.0 degrees Celsius.

In accordance with yet another aspect of the invention, the RFD) label may also have a transformative indicia, such as a temperature, chemical of electrical current sensitive ink that appears in response to the occurrence of a triggering event.

In accordance with yet another aspect of the invention, the RFID label's sensor may be selected from any or all of a temperature sensor, humidity sensor, light sensor, water sensor, shock sensor, motion sensor, accelerometer sensor, water quality sensor, microbial pathogen sensor, time sensor, or location sensor.

In accordance with yet another aspect of the invention, the RFID label may be a single use device with a relatively low manufacturing cost.

In accordance with yet another aspect of the invention, the RFID label and interrogation device may be included in a system in which one or more of the RFID label's response signals are transmitted to a computer via one or more interrogation device.

In accordance with yet another aspect of the invention, a method is provided for receiving an interrogation signal at an antenna, including providing power to the smart label circuit and integrated sensor, activating the sensor to acquire a data component and storing data component on the smart label.

In accordance with yet another aspect of the invention, a method is provided for transmitting a response signal, including generating a response signal including a data component and unique label identification component at the smart label circuit, and transmitting the response signal from the receiver.

In accordance with yet another aspect of the invention, a method is provided for detecting an absent or missed response signal, including sensing the absence of an expected or anticipated response signal, and transmitting an interrogation signal to all or some designated RFID labels in a network or system to energize the designated RFID labels and verify the absent or missed response signal from an RFID label on the network or system.

In accordance with yet another aspect of the invention, a method is provided for detecting a response signal generated from an RFID label at a plurality of interrogation devices in response to an interrogation signal, wherein one or more interrogation device is located in a plurality of discrete networks or systems. That is to say, a method is provided for detecting an RFID label as it travels between multiple discrete networks or systems, each network or system including at least one interrogation device.

In accordance with still yet another aspect of the invention, a method is provided for detecting an RFID label specific to a network or system as it travels between multiple discrete subsystems within the network or system, each subsystem including at least one interrogation device.

In accordance with still yet another aspect of the invention, a smart label is formed from an electrical circuit affixed to a flexible substrate having a sensor configured to generate a data component in response to an environmental parameter and an antenna or other wireless receiver in electrical communication with the sensor. When the receiver receives an incoming radio frequency interrogation signal, the label transmits a radio frequency response signal including a data component provided by the sensor and smart label identification component configured to identify a value of interrogation signals received at the smart label. The electrical circuit also received its power supply from a wireless signal received by the antenna.

These and other objects, advantages, and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention is illustrated in the accompanying drawings in which like reference numerals represent like parts throughout, and in which:

FIG. 1 is a top plan view of a RFID label in accordance with an embodiment of the invention, showing the RFID label partially folded, thereby revealing a portion of a top and bottom surface;

FIG. 2 is a schematic view of the antenna and sensor of the RFID label of FIG. 1, showing an exemplary interrogation signal and a series of response signals transmitted therefrom;

FIG. 3 is an isometric view of a method of manufacturing the temperature sensor of the RFID label of FIG. 1, showing the formation of the temperature sensor via dielectrophoresis;

FIGS. 4a-c are schematic views of the method of manufacturing the temperature sensor of the RFID label of FIG. 1, showing the formation of the temperature sensor via electron-beam lithography in a first step and dielectrophoresis in a second step;

FIG. 5 is an illustrative flow chart of the operation of a system including the RFID label of FIG. 1, showing a plurality of RFID labels in communication with an interrogator device and a computer;

FIGS. 6a and b are top plan views of an animal cage including an alternative embodiment of the RFID label of FIG. 1, configured to sense the presence of water in the animal cage;

FIG. 7 is a top plan view of an animal cage including two RFID labels of FIG. 1, configured to sense the presence of water in the animal cage via relative temperature differential;

FIG. 8 is an illustrative flow chart of an alternative embodiment of the RFID label of FIG. 1 which is affixed to a blood donation bag and which configured to sense the temperature of blood contained within the; and

FIG. 9 a top plan view of a packaged perishable food product including an alternative embodiment of the RFID label of FIG. 1 adhered to the packaging of the perishable food product, the RFID label configured to sense the temperature of perishable food product contained within the package, and bearing multiple transformable indicia for ease of visual inspection.

### DETAILED DESCRIPTION OF THE PREFERRED EMBODIMENT

A wide variety of labels could be constructed in accordance with the invention as defined by the claims. Hence, while several exemplary embodiments of the invention will now be described, it should be understood that the invention is in no way limited to any of those embodiments.

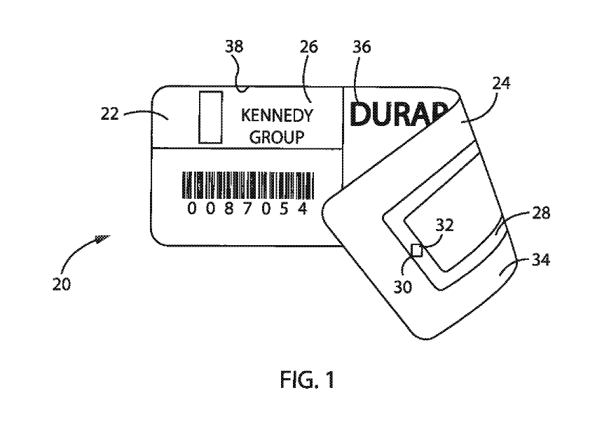

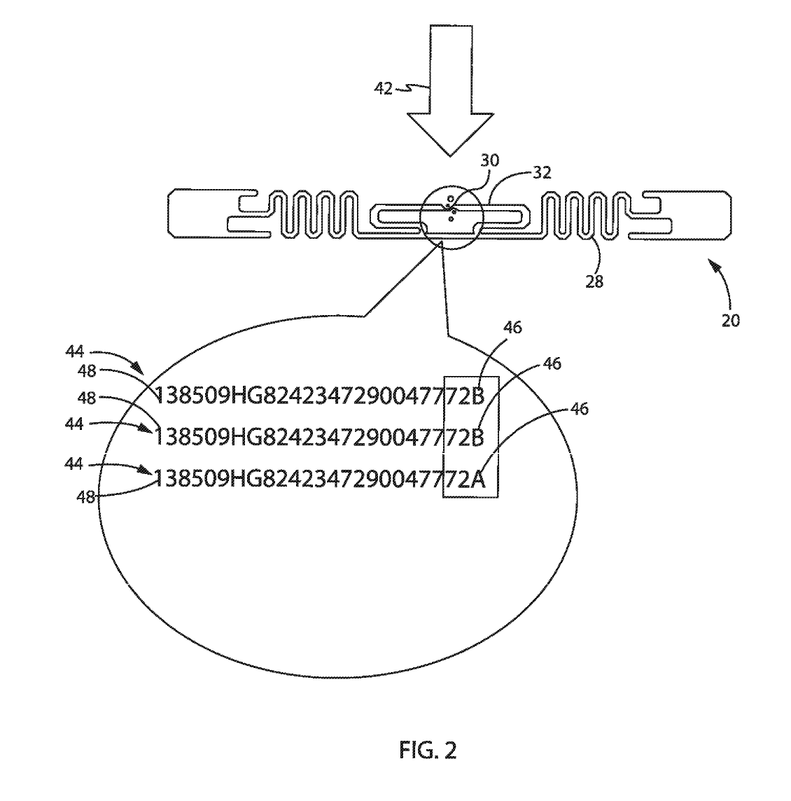

FIGS. 1-2 illustrate a smart label 20 in accordance with one embodiment of the present invention. In this embodiment, the smart label 20 is a passive radio frequency identification enabled label. Alternatively, the smart label 20 may be configured to transmit and receive data via non-radio frequency electromagnetic waves. Referring initially to FIG. 1, the RFID label 20 includes a substrate 22. The substrate 22 may be formed of a material that is a durable yet flexible, such as a thin film of material. Acceptable materials include, but are not limited to polypropylene, polyvinyl-chloride, polyethylene terephthalate, cellulose, paper, laminated paper, thin film, or composites of one or more of these or similar materials. In one embodiment the thin film of material has a thickness of approximately between 0.025 mm and 3.0 mm; and flexibility defined by a stiffness comparable to the stiffness of flexible RFID labels presently known in the art. The flexible substrate 22 includes a first surface 24 and an opposed second surface 26. As illustrated in FIG. 1, a wireless receiver in the form of a radio frequency antenna 28 is disposed on the first surface 24 of the substrate 22. Alternatively, the antenna 28 may be disposed on the opposed second surface 26, within the substrate 22, printed onto the substrate 22, or otherwise associated therewith. A sensor 30 is also integrated into a microprocessor chip 32 that is in electrical communication with the antenna 28. Alternatively, the sensor 30 may be removably attached to the chip 32, or may be remotely located relative to the chip 32 and communicate with the chip 32 either directly or wirelessly. As will be described in further detail below, the sensor 30 may be selected from one or more of a temperature sensor, humidity sensor, light sensor, water sensor, shock sensor, motion sensor, accelerometer sensor, water quality sensor, microbial pathogen sensor, time sensor, or location sensor. A coating 34, such as an adhesive may then be applied to the first surface 24 of the flexible substrate 22, covering the antenna 28 and sensor 30 containing chip 32. In one embodiment, as shown in FIG. 1, the adhesive coating 34 may allow the RFID label 20 to be selectively adhered to any appropriate receiving surface. In this orientation, the opposing second surface 26 of the substrate 22 forms an outwardly-facing surface and may include marking, printing, or indicia 36 as will be described in further detail below.

In one embodiment of the present invention, multiple RFID labels 20 may be manufactured in accordance with the above configuration on an elongated roll of substrate 22 material. Once assembled, the individual RFID labels may be completely cut out of the elongated roll of substrate 22 material. Alternatively, the edges 38 of the RFID labels may be partially punched or cut with a perforation in the elongated roll of substrate 22 material or otherwise perforated, thinned, or weakened at specified locations to facilitate separation at designated locations, thereby allowing entire rolls of RFID labels 20 to be shipped to a user, and allowing the user to remove RFID labels 20 from the roll of substrate 22 material as needed. In this embodiment of the present invention, the RFID label 20 may be a low-cost single use devise.

The size of the RFID label's 20 substrate 22 may be varied according to the application for the given RFID label 20, provided that the substrate 22 is large enough to receive the antenna 28 and chip 32 thereon. In one embodiment, the label 20 may have a width of approximately between 2.0 cm and 12.0 cm, and a length of approximately between 2.0 cm and 12.0 cm. However, as will be described in further detail below, the label 20 may be sized comparably to non-smart labels presently available in corresponding applications. For example, a label 20 to be applied in applications in the food services industry may have an approximate size of 2.5 cm by 2.5 cm, while a label 20 to be applied to a bag of donor blood may have an approximate size of 5.0 cm by 2.5 cm. Again, these sizes are provided by way of illustration and are in no way intended to limit the size of the label 20 according to the present invention.

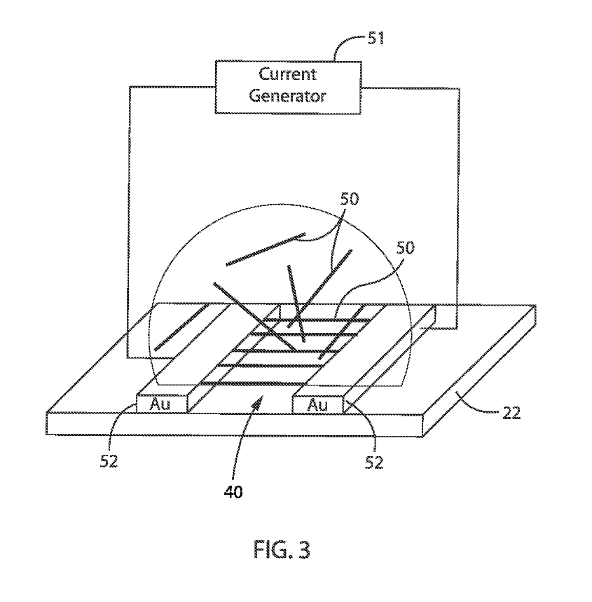

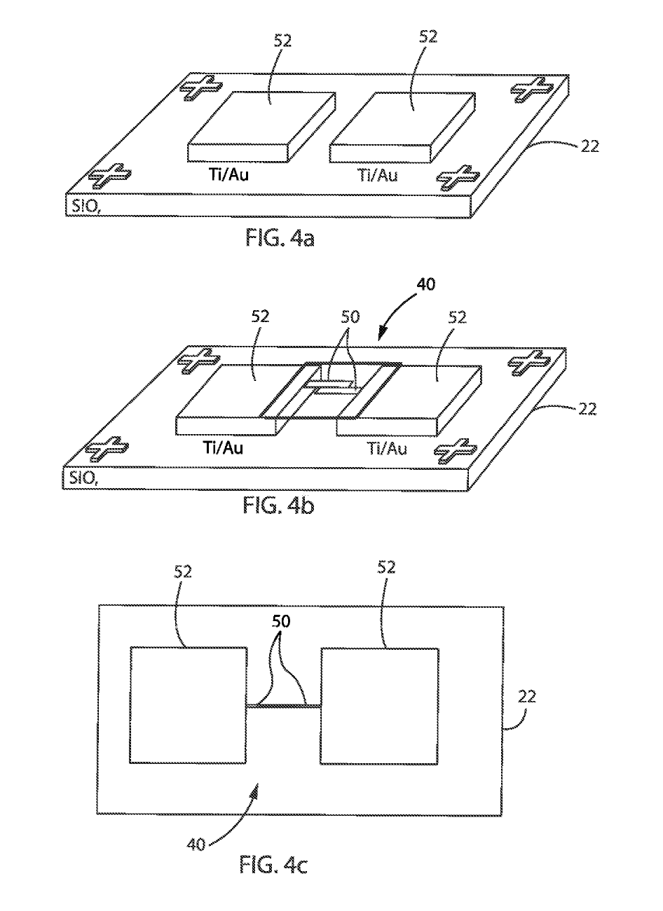

The sensor could comprise one or more of any of a variety of different sensors, including but not limited to a temperature sensor, a humidity sensor, a light sensor, a water sensor, a shock sensor, a water quality sensor, a microbe sensor, a time sensor, or a location sensor. Referring now to FIGS. 2-4 and initially FIG. 2, a temperature sensor 40 is illustrated. The temperature sensor 40 may be formed from a carbon nanotube (CNT) array, and more specifically, may be formed from a suspended semiconducting single walled carbon nanotube (SWNT) array suspended between micro-scale electrodes as illustrated in more detail in FIGS. 3 and 4. A CNT-based temperature sensor 40 is desirable given that CNTs provide a relatively fast response, a ultra-small size, a shelf life of greater than approximately 2.5 years, a temperature sensitivity within plus or minus 1.0 degrees Celsius, a resistance to chemical and moisture exposure, and exhibit low power consumption as to prevent heat production that may adversely impact temperature readings. However, other temperature sensors could be employed as well, so long as they can be integrated with a label.

Still referring to FIG. 2, in operation of the embodiment in which the RFID label 20 includes a temperature sensor 40, the antenna 28 will initially receive an incoming interrogation signal 42 from an interrogator device 58, as will be discussed in further detail below. The incoming interrogation signal 42 preferably may have a frequency in the spectrum of radio waves, i.e., between 3 kHz to 300 GHz, that is configured to be received by the antenna 28. In response to receiving the incoming interrogation signal 42, the RFID label 20 may transmit one or more response signals 44. Each response signal 44 transmitted from the RFID label 20 may include both a unique label identification component 48 provided by the chip 32 and a data component 46 subset provided by the temperature sensor 40. That is to say, the unique label identification component 48 may include a dynamically-manipulated portion that specifically includes the temperature data component 46 in the response signal 44. The temperature data component 46 is generated in the chip 32 at the temperature sensor 40.

In one embodiment of the invention, the response signal 44 may be transmitted via the antenna 28 at an ultra high frequency in a range of approximately between 300 MHz and 3,000 MHz. However, other transmission frequency ranges suitable for use in wireless transmission RFID applications are also considered within the scope of this invention.

Power utilized by the RFID label 20 in the process of generating both the data component 46 and unique label identification component 48 as well as transmitting the response signal 44 may be provided to the RFID label 20 by way of the interrogation signal 42. In this configuration, the RFID label 20 is a passive RFID label, that is to say it does not contain an internal power supply such as a battery or capacitor. However, in an alternative embodiment of the present invention, the RFID label 20 may be an active RFID label and include a dedicated power supply therein.

Turning now to FIGS. 3 and 4, the SWNT-based temperature sensor 40 employed by this embodiment of the present invention may be formed via a dielectrophoresis process. In accordance with this process, the carbon nanotubes 50 are initially suspended in deionized water and assembled between two electrodes 52 mounted on a silicon chip 32. The electrodes may, for example, be formed from tungsten and/or gold A 2 Vrms voltage at a frequency of 1 MHz is passed through the electrodes 52, as shown in FIG. 3. The electrodes 52 may have a thickness of approximately 50 nanometers and spacing of approximately 1 micrometer and may be directly adhered to the RFID label 20 substrate 22 via electron beam lithography, as shown in FIGS. 4a-4c.

In use, as the temperature surrounding the temperature sensor 40 rises, the conductivity of the semiconducting SWNTs increases due to the increased number of charge carriers in the SWNTs. Resultantly, the SWNT-based temperature sensor 40 exhibits a negative temperature coefficient, i.e., the resistance in the temperature sensor 40 decreases with increased temperature. The resultant data signal generated by the temperature sensor 40, which is initially formed in the range of microvolts or lower, is then amplified into the milivolts range at an amplifier on the chip 32. The amplified signal provides temperature readings with an accuracy of plus or minus 1.0 degrees Celsius. The resultant amplified signal is then stored as the temperature data component 46, which is transmitted from the RFID label 20 in the form of the response signal 44. Storage of the temperature data component 46, along with other data including but not limited to the unique label identification component 48, an interrogation identification component (as is described below), and a history of prior temperature data may be stored on the chip 32 in a memory component or an alternative data storage device located on the RFID label 20.

In addition to the unique label identification component 48 and the temperature data component 46, the response signal 44 may also include an interrogation identification component. In one embodiment, this interrogation identification component may be a counter. Provided that the RFID label 20 receives interrogation signals 42 on a frequent and/or consistent basis, the chip 32 may continually count the number of interrogation signals 42 received by the RFID label 20. By associating the response signal 44 with the corresponding interrogation identification component, e.g., count value, a time stamp can be provided for any given response signal 44 transmitted from the RFID label 20. The time stamp will then allow a user to identify the temperature of any given RIFD label 20 at a specified time by correlating the unique label identification component 48, the temperature data components 46 and the interrogation identification component.

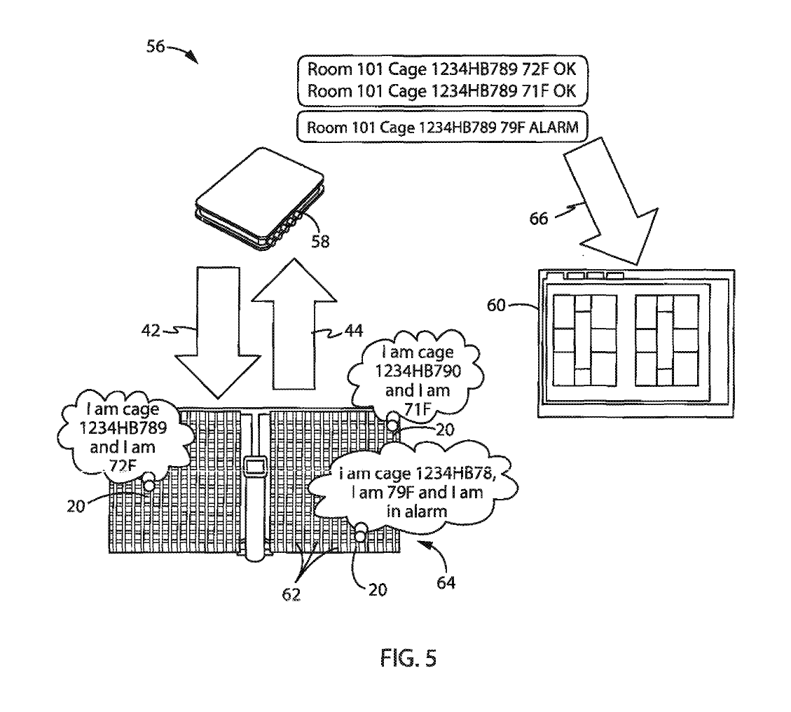

Turning now to FIG. 5, in use, a plurality of RFID labels 20 may be incorporated into a system 56 that also includes one or more interrogator devices 58 and one or more computers 60. The interrogator device 58 may be a two-way radio frequency transmitter-receiver that transmits both an interrogation signal 42 to the RFID labels 20 as well as a power supply, e.g. radio energy, and also receives the response signals 44 from the RFID labels 20. In one embodiment the interrogation signal 42 may constitute the power supply signal receive by the RFID labels 20, as shown in FIG. 5, whereas in an alternative embodiment the interrogation signal 42 may be separate from the power supply signal generated by the interrogator device 58.

The interrogator device 58 may be mobile such as a hand-held or vehicle mounted device. Alternatively, the interrogator device 58 may be located in a fixed location, wherein it creates a fixed interrogation zone that defines a specific geographic location for transmitting interrogation signals 42 and receiving response signals 44. While not shown in FIG. 5, the system 56 may also include a plurality of interrogator devices 58 that may be any combination of mobile and/or fixed interrogator devices 58, wherein the RFID labels 20 may travel between different interrogation zone and be handed off between separate interrogator devices 58 within the system 56. In one embodiment of the system 56, each of the RFID labels 20 may be located at a discrete location, such as in an animal cage 62 located on a rack 64 of animal cages 62 located in a laboratory setting. In this embodiment, the rack 64 of animal cages 62 may include or be located in radio frequency transmission range of an interrogator device 58 that transmits an interrogation signal 42 to each of the RFID labels 20 in the manner described above. In response to receiving the interrogation signal 42, and the provided power associated with that interrogation signal 42, the temperature sensor 40 of each RFID label 20 will generate a temperature data component 46, and the RFID label 20 will transmit a response signal 44, also in the manner described above. After the interrogator device 58 has received the one or more response signals 44, it may relay the response signals 44 to the computer 60 by way of transmitting a response relay signal 66. The interrogator device 58 may communicate with the computer 60 wirelessly or via wired connection.

The computer 60 may be located either at or near the general location of the RFID labels 20 or remotely from that location. The computer 60 may, for example, be a desk-top computer, a personal computer, a laptop, a handheld computing device such as a tablet, a mobile phone, a computer server, or a cloud-based computing system. The computer can also be a combination of two or more of these or other devices that communicate with each other either in a wired-fashion or wirelessly. The computer 60 may receive response relay signals 66 from one or more interrogator devices 58. The computer 60 may be programmed with software that monitors the response signals 44 from multiple RFID labels 20 simultaneously. Upon receiving the response relay signals 66, the computer 60 may alert a user to an alarm condition present in a specific animal cage 62 if the temperature data component 46 of a given response signal 44 triggers an alarm status, i.e., if the sensed temperature is above or below a predetermined threshold value. By way of monitoring the alarm condition with the aid of the computer 60, the user, the computer 60 itself, or another computer in direct or indirect communication with the computer 60 may then quickly identify an undesirable environmental condition associated with one or more specific RFID labels 20 and take the necessary corrective measures in a timely fashion. That action may include, for example, one or more of generating a warning signal that is displayed audibly and/or visually and turning one or more pieces of equipment on or off. Additionally, the computer 60 and/or another computer in direct or indirect communication with the computer 60 may maintain a record of the data component 46 received via the response relay signals 66, and generate a log or record of the environmental parameters sensed by the sensors 30. An example of a software package capable of monitoring signals provided by an interrogator and of generating warning signals or otherwise triggering a response is a vivarium management system available from Edstrom Industries, of Waterford Wis., under the brand name Pulse™ or Pulse CMC™.

In the event that a temperature sensor 40 on a given RFID label 20 malfunctions and is not able to generate the temperature data component 46 in response to receiving an interrogation signal 42, the temperature sensor 40 may generate an error status signal in the temperature data component 46. Accordingly, rather than simply repeating the previously-sensed temperature data, the RFID label 20 can alert the computer 60 of the malfunction in the temperature sensor 40. In one embodiment, generating an error status signal in the temperature data component 46 will trigger an alarm status at the computer 60, thereby allowing the user to quickly identify the specific malfunctioning RFID label 20.

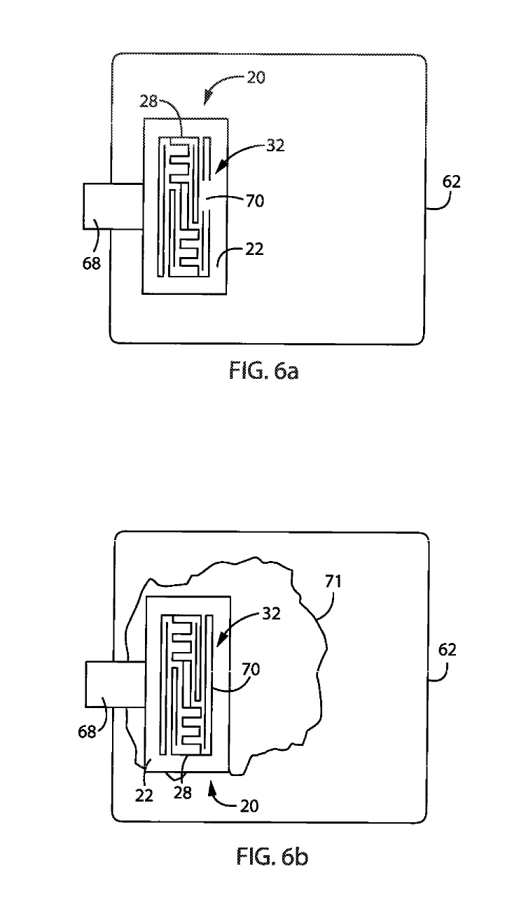

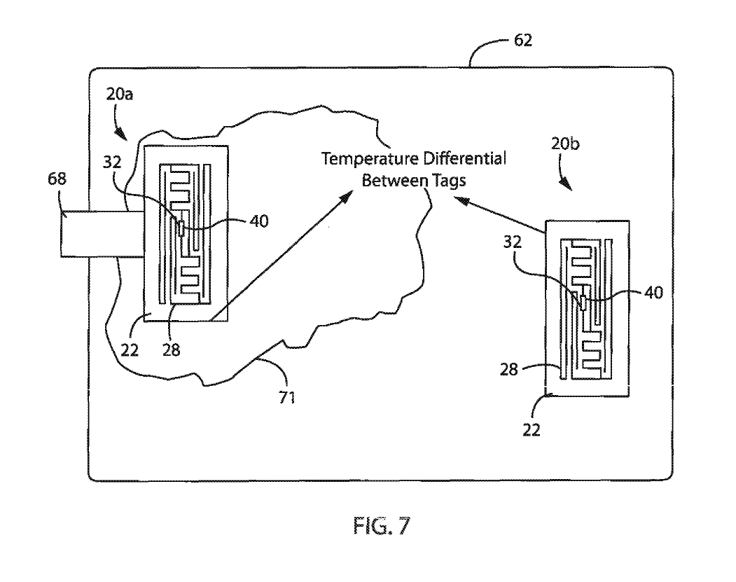

Turning now to FIGS. 6 and 7, in an alternative embodiment of the present invention, also related to a laboratory application, one or more of the RFID labels 20 may be placed within an animal cage 62 located on a rack 64 of animal cages 62. Each animal cage 62 is supplied with a water source 68. In this embodiment, the sensor 30 that is located on the chip 32 of the RFID label 20 may be a fluid sensor 70 that utilizes fluid to complete an electrical circuit in the fluid sensor 70. For example fluid sensor 70 may identify the presence of a fluid through the monitoring of one or more monitorable characteristics such as conductivity, resistancivity, capacitance, acoustics, and visually monitorable characteristics. In use, the fluid sensor 70 may identify a monitorable characteristic that is out-of-range relative to a preferred predetermine range, when the fluid sensor 70 is exposed to fluid. In response, the fluid sensor 70 may then generate a data component 46 within the response signal 44 that is indicative of exposure to fluid at the fluid sensor 70. As such, the RFID labels 20 may be located on the inner floor of base of the animal cages 62 as to detect an undesirable volume of standing water 71 within the animal cage 62. Accordingly the data component 46 of the response signal 44 will indicate the absence or presence of fluid or standing water 71 at the location of the fluid sensor 70. As shown in FIG. 6a, when the water source 68 is functioning properly and has not developed a leak, the fluid sensor 70 typically will not be activated. Accordingly, the RFID label 20 response signal 44 will indicate a normal condition in the animal cage 62. Alternatively, as shown in FIG. 6b, when the water source 68 malfunctions and develops a leak that results in a volume of water 71 within the animal cage 62 that is standing or otherwise detectable by the fluid sensor 70, the fluid sensor 70 may be activated. In response to activating the fluid sensor 70, the data component 46 of the associated RFID label's 20 response signal 44 will change to indicate the presence of fluid in the animal cage 62. This change in the data component 46 may trigger an alarm condition at the associated computer 60, as generally described above, and will allow a user to quickly identify an undesirable leak associated with one or more specific animal cages 62 and take the necessary corrective measures in a timely fashion. The computer 60, or another computer in communication with computer 60, also could turn off a valve associated and/or take other automatic corrective or remedial action.

In yet another alternative embodiment of the present invention, the above-discussed leak condition in an animal cage 62 may be alternatively identified by using multiple temperature sensing RFID labels 20 in a single animal cage 62, and assessing a temperature difference between those multiple RFID labels 20 as illustrated in FIG. 7, provided that the water from the leaking water source 68 lowers the temperature surrounding one of the RFID labels 20. That is to say, a first temperature sensing RFID label 20a may be placed on the inner floor of base of the animal cages 62 adjacent the water source 68, while a second temperature sensing RFID label 20b may be placed on the animal cages 62 at a location relatively removed from the water source 68, preferably but not necessary at a location above and spaced from the location of label 20a. If the water supplied via the water source 68 forms a leak that results in a volume of water 71 detectable by sensor 20a, and that volume of water 71 has a temperature that is different from the air temperature, then the resulting temperature data component 46 in the response signals 44 of the first and second RFID labels 20a, 20b will differ. This difference in the temperature data component 46 of the response signals 44 of two or more RFID labels 20 within the same animal cage 62 may trigger an alarm condition at the associated computer 60, as generally described above, and will allow a user, the computer 60, or another computer in communication with the computer 60 to quickly identify an undesirable leak associated with one or more specific animal cages 62 and take the necessary corrective measures in a timely fashion.

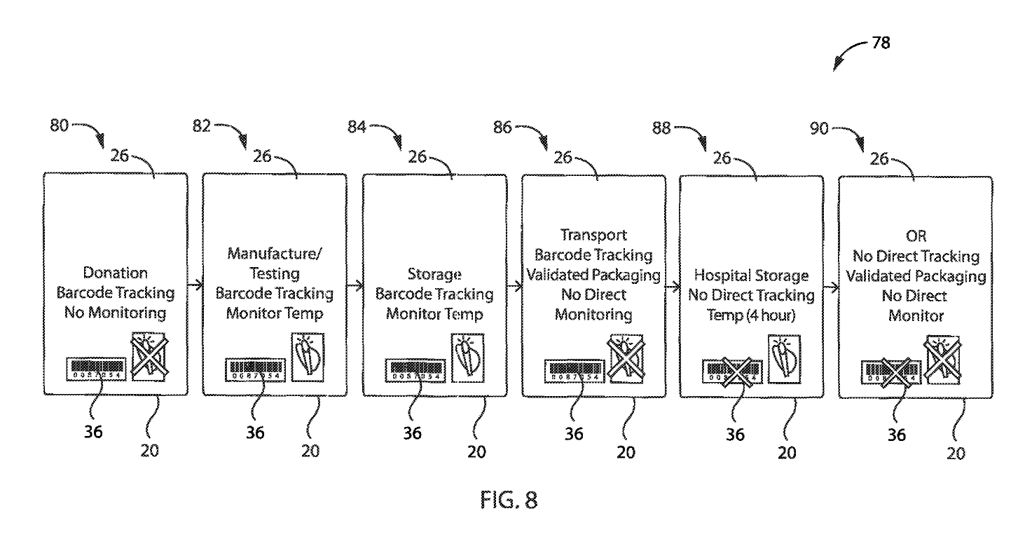

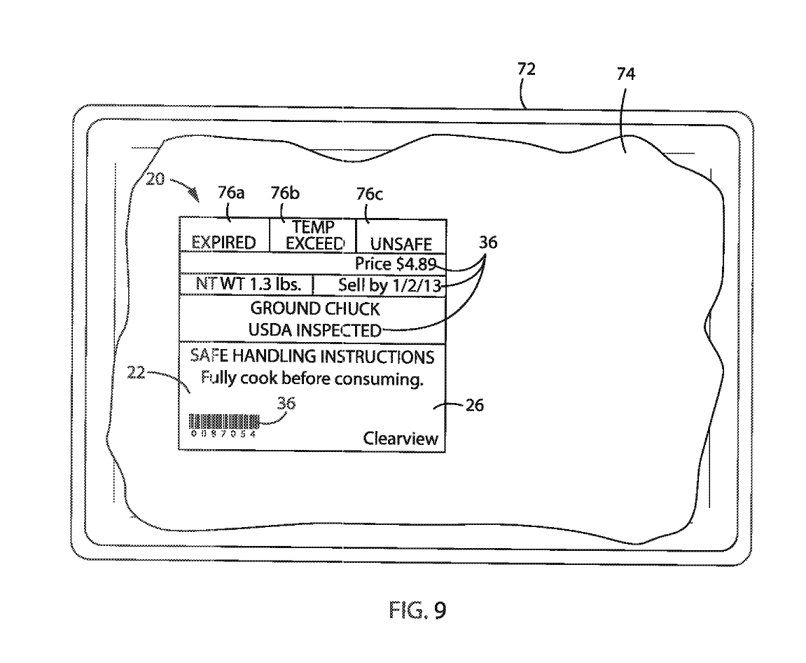

Turning now to FIGS. 8 and 9, the temperature sensor 40 based RFID labels 20 as described herein also may be implemented in mobile or transportation related applications. For example, an RFID label 20 including a temperature sensor 40 may be utilized in the medical field, such as in association with blood donation, for monitoring the location and temperature of a flexible plastic bag (not shown) containing donated blood. FIG. 8 illustrates a visual flow chart 78 of the RFID label 20 as it and the associated flexible plastic bag containing donated blood travels through various steps in the blood donation chain of custody. In this embodiment, an RFID label 20 may be adhesively affixed to the exterior of a flexible plastic bag (not shown) containing or configured to contain donated blood. The RFID label 20 may include an identifying indicia 36 located on the outwardly-facing second surface 26 of the substrate 22, such as a barcode and/or text displaying blood type information. The barcode indicia 36 allows for the blood bag associated with the RFID label 20 to be scanned and tracked as it travels between various locations including but not limited to: a blood donation location, a testing facility, a blood bank storage facility, a transportation vehicle, a hospital storage, and a hospital usage site. Additionally, the temperature sensor 40 allows the temperature of the blood contained in the bag to be validated throughout the chain of custody via transmission of a response signal 44 in response to receiving an interrogation signal 42 in accordance with the method generally described above. That is to say, during select phases, such as testing, blood bank storage, and hospital storage, the RFID label may be associated with an interrogator device 58 and computer 60, in accordance with the method previously described, to confirm that the temperature of the blood in the bag associated with a specific RFID label 20 is consistently maintained below a threshold temperature in order to ensure the viability of the blood and reduce the unnecessary discard of blood that was otherwise not validated throughout the chain of custody.

Specifically, in the initial step of the flow chart 78, at block 80, a volume of blood is donated and placed into the flexible plastic bag containing a RFID label 20 according to the present invention. At block 80, the barcode indicia 36 may be scanned to collect location tracking information, but no interrogation signal 42 is supplied and no temperature data obtained through a response signal 44. After collection, the donated blood undergoes various blood bank testing at block 82, and is subject to location tracking through the scanning of the barcode indicia 36 and temperature monitoring via a response signal 44 generated in response to an interrogation signal 42. This temperature monitoring ensures that the blood does not exceed the threshold temperature during blood testing. After testing, the donated blood is stored in a blood bank storage facility at block 84, where its storage location may be verified through scanning of the barcode indicia 36 and its temperature regularly monitored via a response signal 44 generated in response to a periodically generated interrogation signal 42. When blood is then needed at a medical facility, such as a hospital, the blood bag may be transported from the blood bank storage facility to the medical facility at block 86. During transportation, scanning of the barcode indicia 36 one or more times allows the location of the blood bag to be verified throughout the transportation process. If either the vehicle or its driver is equipped with an interrogator device 58, the temperature of the blood bag may also be regularly monitored via response signals 44 generated in response to periodically generated interrogation signals 42 throughout the transportation process. At subsequent block 88, the blood bag may then be held in on-site storage at the hospital or medical facility. Once the blood bag has been placed into the on-site storage, its location need not be validated through the scanning of the barcode indicia 36; however, its temperature may be periodically monitored via a response signal 44 generated in response to a frequently and/or consistently generated interrogation signal 42, to ensure that the blood does not exceed a threshold temperature. At the final block 90, when the donated blood is required for use, such as during a surgical procedure in an hospital operating room scanning of the barcode indicia or monitoring of temperature via response signal 44 is no longer required. However, in an alternative embodiment, regularly monitoring temperature via a response signal 44 generated in response to a periodically generated interrogation signal 42 in the operating room ensures that the threshold temperature is not exceeded prior to usage. Additionally, if the blood bag was not used during the surgical procedure, it may then be returned to the hospital storage facility, at block 88, provided that its monitored temperature never exceeded a threshold temperature while in the operating room, at block 90. While the proceeding steps of the flow chart 78 are considered one embodiment of the present invention, other steps, including variations of location tracking via scanning of the barcode indicia 36 and temperature monitoring via a response signal 44 generation are considered well within the scope of this invention.

Turning now to FIG. 9, in another embodiment the temperature sensor 40 based RFID label 20 may also be implemented in the food safety industry and, specifically, adhered to food packaging. As illustrated in FIG. 9, the RFID label 20 including a temperature sensor 40 may be directly applied to the packaging 72 of a perishable food product 74 such as ground beef. In this embodiment, an RFID label 20 is shown adhesively affixed to the exterior plastic coating surrounding ground meat.

The RFID label 20 may include an identifying indicia 36 located on the outwardly-facing second surface 26 of the substrate 22. The identifying indicia may include various information such as a barcode, and/or text common to standard grocery store labels, including but not limited to content identification, price, sale date, weight, etc. Additionally, in the illustrated embodiment, the identifying indicia 36 may also include one or more transformative indicia 76. In FIG. 9, the transformative indicia 76, is shown in a visible state in response to one or more independent triggering event. Specifically, transformative indicia 76a displays the text “expired,” transformative indicia 76b displays the text “temp exceeded,” and transformative indicia 76c displays the text “unsafe.” These transformative indicia 76 may be formed from a temperature, chemical or electrical current sensitive ink that appears in response to the occurrence of a triggering event such as exceeding a predetermined time period, temperature threshold or exposure to other undesirable environmental parameters. In one embodiment, the appearance of the transformative indicia 76 may be triggered independently of any signals received from the RFID label 20 circuitry. Alternatively, the appearance of the transformative indicia 76 may be selectively triggered by the response signal 44 transmitted by the RFID label 20. Such transformative indicia 76 also may also be employed in the other embodiments described herein, for example on the label associated with the blood donation bag illustrated in flow chart 78 of FIG. 8. The use of transformative indicia provides the additional benefit of triggering an alarm without requiring electronic transmission via the interrogator 58 or otherwise.

As used in FIG. 9, the RFID label 20 may be adhered to the packaging 72 of perishable food products 74 at a point of manufacture. During the subsequent transportation of the perishable food products 74, for example in a refrigerated truck, the RFID labels 20 may receive interrogation signals 42 from an interrogator device 58 located on the refrigerated truck or elsewhere. The interrogator device 58 may then receive the corresponding response signals 44 and relay the response signals 44 via response relay signals 66 to a computer 60. The computer in this instance may be one or more of the vehicle driver's mobile phone, a portable computer, a remotely-located dispatch computer, a private or government-agency's monitoring computer, or even the customer's computer. Additionally, a log or report of the temperature data components 46 associated with the response signals 44 and their corresponding time stamps may be recorded to further validate maintenance of the required temperature parameters during transportation of the perishable food products 74. Upon delivery of the perishable food products 74 to the customer, the driver of the refrigerated truck may provide the log or report of the temperature data component 46 associated with each applicable RFID label 20 to ensure that the perishable food products 74 did not exceed the required temperature parameters during transportation. Furthermore, each of the RFID labels 20 may be visually inspected for the appearance of any transformative indicia 76 on the substrates 22 that would indicate a temperature parameter had been exceeded, as a form of redundancy and/or confirmation.

Many changes and modifications could be made to the invention without departing from the spirit thereof. The scope of these changes and modifications will become apparent from the appended claims.

I claim:

1. A smart label, comprising:
a substrate;
an electrical circuit affixed to substrate, the electrical circuit comprising:
a receiver configured to receive an interrogation signal and transmit a response signal; and
a sensor configured to monitor an environmental parameter and to generate a data component indicative of a characteristic of the environmental parameter, wherein the response signal comprises the data component.

2. The smart label of claim 1, wherein the receiver is configured to receive and transmit signals in a radio frequency.

3. The smart label of claim 1, wherein the receiver is an antenna, and wherein the electrical circuit receives power from a signal received by the antenna.

4. The smart label of claim 3, wherein the antenna is configured to transmit a response signal including a smart label identification component in response to receiving the interrogation signal.

5. The smart label of claim 4, wherein the response signal further comprises an interrogation identification component configured to identify a value of interrogation signals received at the smart label.

6. The smart label of claim 4, wherein the response signal has a frequency of approximately between 300 MHz and 3,000 MHz.

7. The smart label of claim 1, wherein the sensor is a temperature sensor.

8. The smart label of claim 7, wherein the temperature sensor has a sensitivity of plus or minus 1.0 degrees Celsius.

9. The smart label of claim 7, wherein the temperature sensor includes a plurality of semiconducting single walled carbon nanotube suspended between micro-scale electrodes.

10. The smart label of claim 9, wherein the data component generated by the temperature sensor comprises initial temperature sensor data, and further comprising an amplifier configured to amplify the initial temperature sensor data to form a final temperature sensor data.

11. The smart label of claim 1, wherein the sensor is selected from at least one of a temperature sensor, a humidity sensor, a light sensor, a water sensor, a shock sensor, a water quality sensor, a microbe sensor, a time sensor, and a location sensor.

12. The smart label of claim 1, further comprising a visual indicia located on the substrate.

13. The smart label of claim 12, wherein the visual indicia is a transformative indicia that is responsive to a trigging event.

14. The smart label of claim 13, wherein the trigging event is a selected from at least one of a temperature value in excess of a maximum threshold temperature, a time duration in excess of a maximum threshold time, and receiving an electrical current from the electrical circuit.

15. The smart label of claim 1, wherein the smart label is a RFID label.

16. A smart label, comprising:
a flexible substrate;
an electrical circuit affixed to the flexible substrate, the electrical circuit comprising:
a sensor configured to generate a data component in response to an environmental parameter;
an antenna configured to receive a radio frequency interrogation signal and transmit a radio frequency response signal in response to receiving the radio frequency interrogation signal, the radio frequency response signal comprising the data component and a smart label identification component configured to identify a value of interrogation signals received at the smart label; and
wherein the electrical circuit is configured to receive a power supply from a signal received by the antenna.

17. The smart label of claim 16, wherein the sensor is a temperature sensor comprising a plurality of semiconducting single walled carbon nanotube suspended between micro-scale electrodes, and the temperature sensor has a sensitivity of plus or minus 1.0 degrees Celsius.

18. A method of activating a sensor on a smart label, comprising the steps of:
transmitting power from a signal received by an antenna to an electrical circuit affixed to a substrate, wherein the electrical circuit comprises the sensor and the antenna;
receiving an interrogation signal at the antenna; and
activating the sensor to generate a data component in response to receiving the interrogation signal.

19. The method of claim 18, further comprising the step of:
transmitting a response signal including a smart label identification component and the data component from the antenna in response to receiving the interrogation signal; and
receiving the response signal at an interrogator device.

20. The method of claim 18, wherein the sensor is selected from at least one of a temperature sensor, a humidity sensor, a light sensor, a water sensor, a shock sensor, a water quality sensor, a microbe sensor, a time sensor, and a location sensor.
